(19) United States
(12) Patent Application Publication
(10) Pub. No.: US 2005/0132289 A1
(43) Pub. Date: Jun. 16, 2005

(54) Method and apparatus for creating and publishing animated print media

(75) Inventor: Cletus J. Welsch, Aurora, IL (US)

Correspondence Address: IP GROUP OF DLA PIPER RUDNICK GRAY CARY US LLP, 1650 MARKET ST, SUITE 4900, PHILADELPHIA, PA, 19103, US

(73) Assignee: Embossed Graphics, Inc.

(21) Appl. No.: 10/737,504

(22) Filed: Dec. 16, 2003

(51) Int. Cl. G06F 3/00

(52) U.S. Cl. 715/700

(57) ABSTRACT

A method for creating an animated image for publishing on print media including selecting a first image, selecting a second image, selecting a movement path for the at least one second image and creating a plurality of image frames, such that the first image comprises a background image which remains stationary in each of the plurality of image frames, and such that the second image moves along the selected movement path so that it is disposed in a different position in each of the plurality of images frames. A tablet formed by this method is also described.

### FIELD OF THE INVENTION

This present invention relates to a method and apparatus for creating and publishing an ‘animated’ print media, and in particular, to a computer-based method and apparatus for modeling and printing an ‘animated’ tablet.

### BACKGROUND OF THE INVENTION

The publishing of personalized stationary and other personalized items has become an increasingly popular trend in both personal and business settings. At present, there are several companies that produce personalized stationary, personalized checks, and other personalized items. Enhancing personalization of items is a key factor in maintaining a viable business position in this environment.

Presently, a computer language entitled Adobe® PostScript® (see “PostScript® Language Reference Manual (Second Edition)”, Copyright 1985, from Adobe Systems Incorporated of San Jose, Calif.) permits the programming of various methods for manipulating images and text, and publishing documents in various media. PostScript® allows publishers to manipulate text and graphics to increase personalization of printed items.

However, there are presently no commercially available programs for generating and publishing a print media (e.g., paper tablet) containing a series of animated pictures on separate pages which may be viewed by ‘fanning’ the series of pages.

Thus, there is presently a need for a system and method for generating and publishing such an ‘animated’ tablet.

### SUMMARY OF THE INVENTION

An exemplary embodiment of the present invention comprises a method for creating an animated image for publishing on print media including the steps of: selecting at least one first image, selecting at least one second image, selecting a movement path for the at least one second image, and creating a plurality of image frames, wherein the at least one first image comprises a background image which remains stationary in each of the plurality of image frames, and wherein the at least one second image moves along the selected movement path so that it is disposed in a different position in each of the plurality of images frames.

An exemplary embodiment of the present invention also comprises a computer system including at least one server computer and, at least one first client computer coupled to the at least one server computer through a network, wherein the at least one server computer includes at least one program stored thereon, said at least one program performing the following steps: selecting at least one first image, selecting at least one second image, selecting a movement path for the at least one second image and creating a plurality of image frames, wherein the at least one first image comprises a background image which remains stationary in each of the plurality of image frames, and wherein the at least one second image moves along the selected movement path so that it is disposed in a different position in each of the plurality of images frames.

An exemplary embodiment of the present invention also comprises a computer readable medium having embodied therein a computer program for processing by a machine, the computer program including a first code segment for permitting the selection of at least one first image, a second code segment for permitting the selection of at least one second image, a third code segment for permitting the selection of a movement path for the at least one second image and a fourth code segment for creating a plurality of image frames, wherein the at least one first image comprises a background image which remains stationary in each of the plurality of image frames, and wherein the at least one second image moves along the selected movement path so that it is disposed in a different position in each of the plurality of images frames.

An exemplary embodiment of the present invention also comprises a computer data signal embodied in a carrier wave including a first code segment for permitting the selection of at least one first image, a second code segment for permitting the selection of at least one second image, a third code segment for permitting the selection of a movement path for the at least one second image and a fourth code segment for creating a plurality of image frames, wherein the at least one first image comprises a background image which remains stationary in each of the plurality of image frames, and wherein the at least one second image moves along the selected movement path so that it is disposed in a different position in each of the plurality of images frames.

An exemplary embodiment of the present invention also comprises a tablet including a plurality of sheets of paper secured together by an adhesive, said tablet formed by the following steps: selecting at least one first image, selecting a movement path for the at least one first image, creating a plurality of image frames, wherein the at least one first image moves along the selected movement path so that it is disposed in a different position in each of the plurality of images frames and printing the plurality of image frames on a corresponding plurality of sheets of paper.

### BRIEF DESCRIPTION OF THE DRAWINGS

FIG. 1 is a block diagram showing a computer system according to an exemplary embodiment of the present invention.

FIG. 2 is a flow diagram showing a method for generating and publishing according to an exemplary embodiment of the present invention.

FIG. 3 is an exemplary image frame showing exemplary images.

FIGS. 4(a)-4(i) show exemplary image frames.

### DETAILED DESCRIPTION

An exemplary embodiment of the present invention comprises a computer-based method for generating and publishing an ‘animated’ tablet or other ‘animated’ print media. The exemplary method involves selecting at least a background image and a moving image, and thereby generating a plurality of animation frames for publishing onto print media, such as a paper tablet.

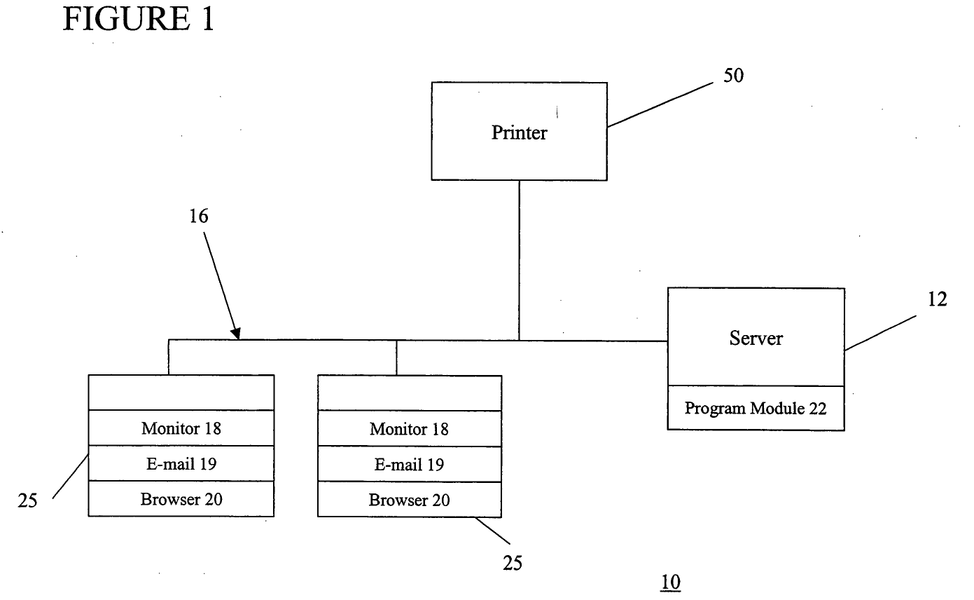

FIG. 1 shows a computer system 10 according to an exemplary embodiment of the present invention. The system includes at least one server computer 12, and a plurality of user computers (clients) 25. The server computer 12 and the user computers 25 may be connected by a network 16 (e.g., Internet, Intranet, etc.). The user computers 25 may be connected to the network 16 by a modem, Local Area Network (LAN), Wide Area Network (WAN), Digital Subscriber Line (DSL), or other equivalent connection means.

Each user computer 25 preferably includes a video monitor 18 for displaying information. Additionally, each user computer 25 preferably includes an electronic mail (e-mail) program 19 (e.g., Microsoft Outlook®) and a browser program 20 (e.g., Microsoft Internet Explorer®, Netscape Navigator®, etc.), as is well known in the art.

The server computer 12 and the plurality of user computers 25 may be coupled to a printer 50 through the network 16. As discussed in detail below, the printer 50 may be used to print a plurality of images onto some print medium (e.g., paper).

The server computer 12 preferably includes at least one program module 22 stored thereon which permits a user stationed at user computers 25 to create, manage and publish print media. The program module 22 preferably comprises an image management and publishing program which permits a user to generate and manage a series of images for producing onto some print media (e.g., paper, etc.). An example of such a program is Adobe® PostScript® (available from Adobe Systems Incorporated of San Jose, Calif.). In an exemplary embodiment of the present invention, the program module 22 comprises a program for generating an Adobe® PostScript® file.

It will be noted that although a client/server system 10 is described above, the program module 22 may be loaded directly on the user computer 25, and the printer 50 may be directly coupled to the user computer, as is well known in the art.

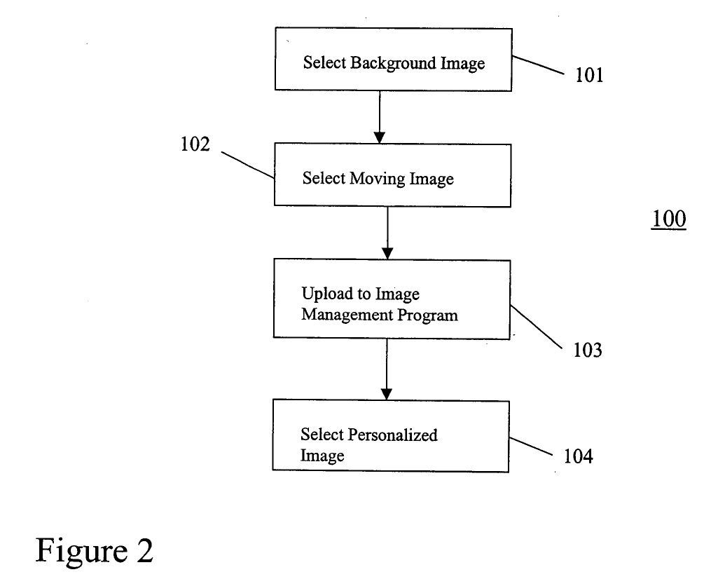

FIG. 2 shows a method 100, according to an exemplary embodiment of the present invention, carried out by program module 22. As an initial step in the method 100, at least one ‘background’ image 1000 and at least one ‘moving’ image 1010 should be selected by a user (steps 101, 102) (See FIG. 3). Selection of both a background image 1000 and a moving image 1010 is not required according to the exemplary method (i.e., only the selection of a moving image is required), however, the presence of a background image adds to the effectiveness of the displayed animation. The background image 1000 is preferably printed in the same position on every page of the print media (e.g., tablet). Conversely, the moving image 1010 will appear in different locations on each page of the print media. For example, the background image 1000 may comprise an image of a train station, and the moving image may comprise a train, as shown in FIG. 3. Once the background and moving images have been selected, the images may be uploaded, or otherwise selected by, an image management and publishing program (step 103), such as the aforementioned Adobe® PostScript® program.

At least one ‘personalized’ image 1020 may also be selected by a user for inclusion on the ‘animated’ tablet (step 104). The personalized image 1020 may be created using the image management and publishing program (e.g., by the insertion of stylized text or stock images which form part of the program), or may be uploaded to the program in the same manner as the background and moving images 1000, 1010.

The above-described image management and publishing program should have the ability to create a movement path for the moving image 1010 (Adobe® PostScript® has such a capability). In particular, the Adobe® PostScript® program includes a function called ‘PATH’ which permits a user to select a particular pattern across which an image, or images, may be moved. Such a path may be in the shape of straight line, or in other various geometric shapes selected by the user.

After the images 1000, 1010, 1020 (optional) and the movement path have been selected, the image management and publishing program is used to create a finite series of image frames. The exact number of image frames necessary to create an animation is dependent upon the images themselves, the complexity of the desired animation, etc. For ease of explanation, it will be assumed that at least nine (9) image frames are necessary to create a proper animation. If available, the PATH function of the image management and publishing program is used to create 9 images frames, such that the moving image 1010 is in a different location along the path in each of the 9 frames. If the image management and publishing program does not have a PATH or similar function, the individual frames may be created by the user, but simply moving the moving image 1020 slightly and saving each time the moving image is displaced as a separate file (e.g., in the above example, there would be nine (9) separate files).

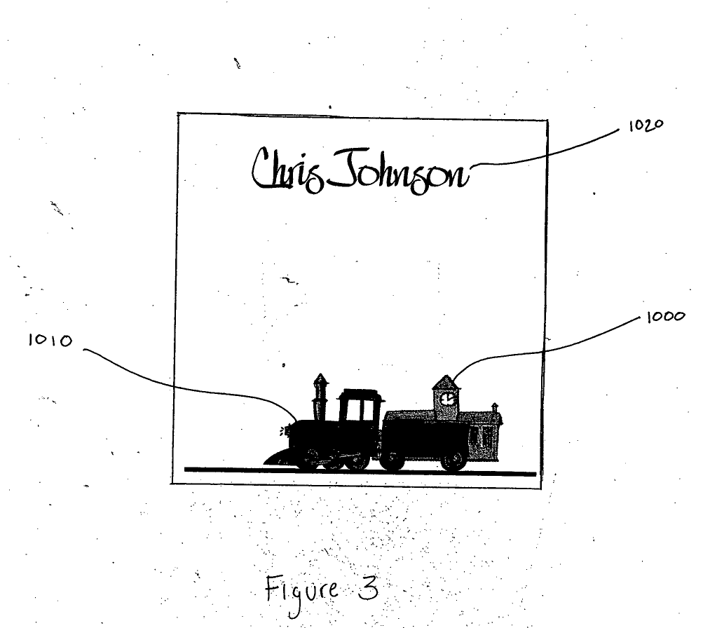

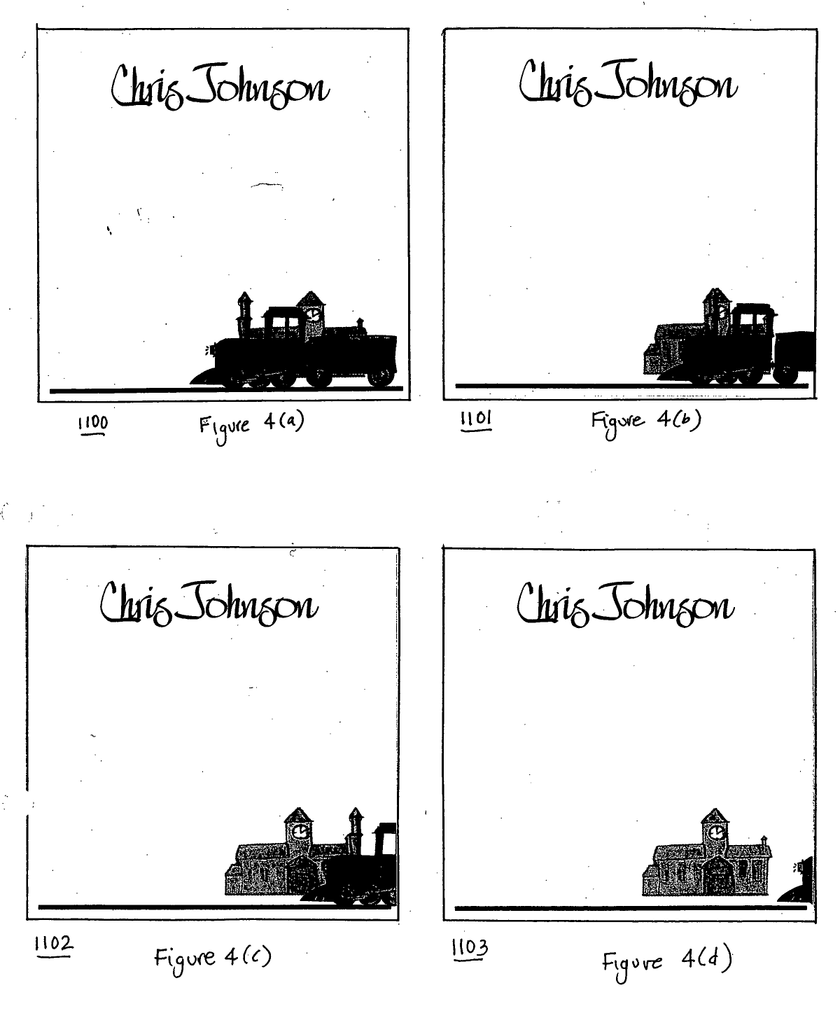

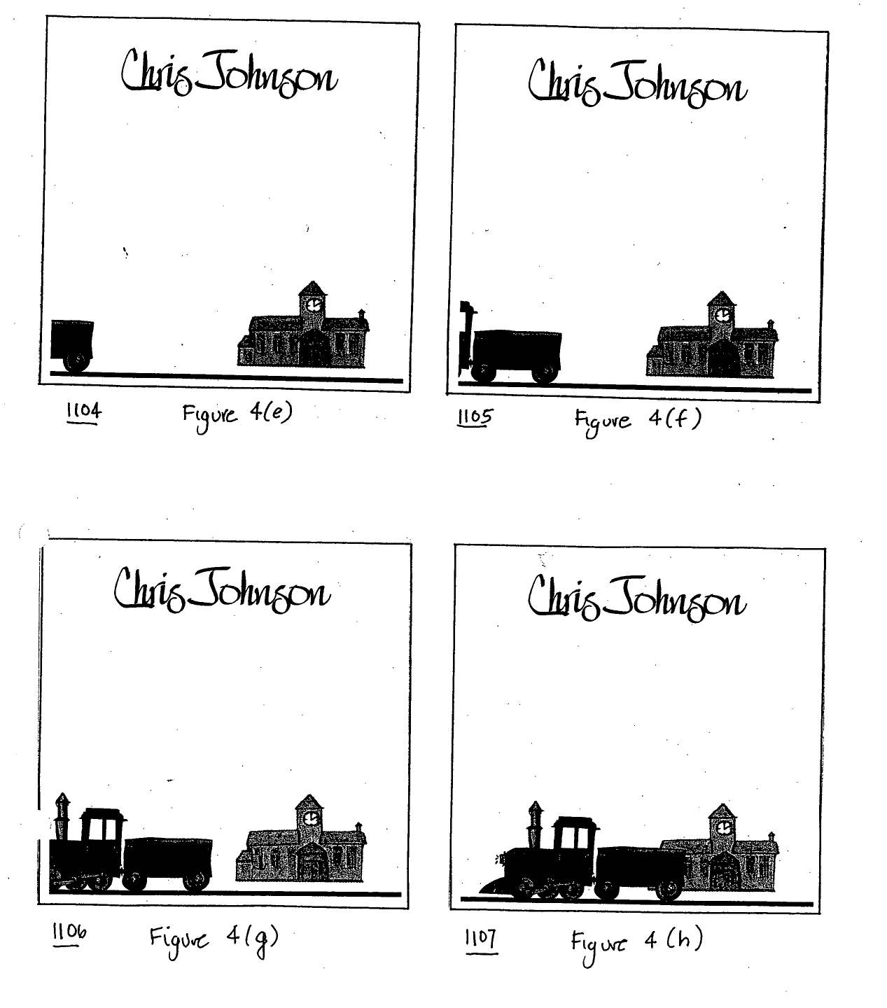

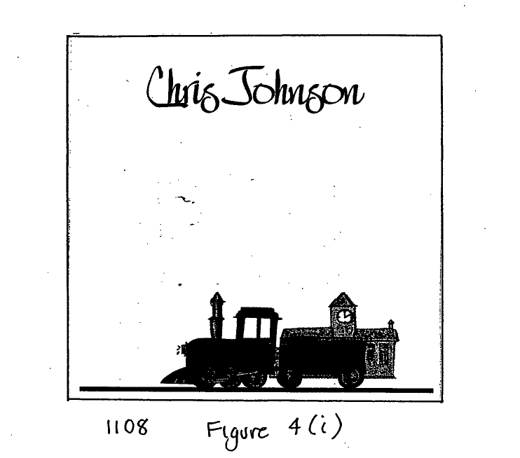

FIGS. 4(a) through 4(i) show a plurality of exemplary image frames 1100-1108 which are used to create an animation of a train passing by a station. This image frames 1100-1108 are preferably displayed on a computer screen (e.g., video monitor 18 of user computer 25) as part of an image management and publishing program (e.g., Adobe® PostScript®). For example, images may be imported into the image management and publishing program, and subsequently transformed into a plurality of image frames 1100-1108 through the above-described ‘PATH’ function, or through manipulation by the user.

As will be noted, the path of the animation is a straight line across the bottom of each of the image frames 1100-1108. Although this is one exemplary path, it will be noted by those skilled in the art that the path may comprise various configurations and shapes (e.g., circle, square, spiral, etc.).

Once the images, movement path, and number of image frames have been selected, the program module 22 generates a computer file including all the information necessary to print the image frames onto some print media (e.g., paper). As discussed above, this computer file is preferably in the format of an Adobe® PostScript® computer file (e.g., a “.ps” file). The computer file instructs a printer (e.g., printer 50) to print the image frames onto some print media (e.g., paper).

The result of the printing the predetermined number of image frames (e.g., image frames 1100-1108) onto some print media (e.g., paper) is a set of pages, each page preferably including one of the image frames. Using the above example, printing the nine (9) images frames 1100-1108 will result in nine (9) separate pages.

Each of the image frames 1100-1108 may be printed on a separate sheet of paper (as mentioned above), or all may be printed onto a single piece of paper, and then later divided by a cutting process. For example, an exemplary printer may have the ability to print twelve (12) images frames per piece of paper, and thus the image management and publishing program would print the image frames in successive order on each piece of paper. For example, the first sheet would include a first set of image frames, and the first three (3) image frames of the following (second) set (totaling 12 images), and the second sheet would include the last six (6) images of the second set of image frames, along with six (6) images from the third set of image frames, and so on. If the tablet were to include on hundred and eight (108) total pages, nine (9) such sheets (of 12 images each) would need to be printed. Once the predetermined number of sheets (e.g., 9) is printed, the sheets may be cut into the predetermined number of tablet sheets (e.g., 12 each), each tablet sheet (sub-component) comprising a single image frame.

Once the proper number of tablet sheets has been printed and cut to size, the tablet sheets are stacked together in groups and secured together by an adhesive (e.g., glue). The tablet sheets should be maintained in the order in which they were printed to maintain the proper animation when the tablet is fully assembled. A firm support member (e.g., cardboard) may also added to the underside of the stack of tablet sheets before the adhesive is applied.

Although the present invention has been described above with reference to a memo or notation tablet, it will be understood by those of ordinary skill in the art that the presently described method is applicable to various print media, such as for example, check books, legal tablets, adhesive notes (e.g., Post-it® notes), and other equivalent products known to those of ordinary skill in the art.

Although the invention has been described in terms of exemplary embodiments, it is not limited thereto. Rather, the appended claims should be construed broadly to include other variants and embodiments of the invention which may be made by those skilled in the art without departing from the scope and range of equivalents of the invention.

1. A method for creating an animated image for publishing on print media comprising the steps of:
selecting at least one first image;
selecting at least one second image;
selecting a movement path for the at least one second image; and,
creating a plurality of image frames,
wherein the at least one first image comprises a background image which remains stationary in each of the plurality of image frames, and wherein the at least one second image moves along the selected movement path so that it is disposed in a different position in each of the plurality of images frames.

2. The method of claim 1, wherein the plurality of image frames comprises nine image frames.

3. The method of claim 1, wherein each of the plurality of image frames are printed on print medium.

4. The method of claim 1, comprising the further step of:
printing the plurality of image frames on a print medium.

5. The method of claim 4, comprising the further step of:
dividing the print medium into a plurality of sub-components, each sub-component corresponding to one of the plurality of print images.

6. The method of claim 5, comprising the further step of:
stacking each of the plurality of sub-components on top of one another in the same order in which they appeared on the print medium.

7. The method of claim 6, comprising the further step of:
applying an adhesive to at least one side of the plurality of stacked sub-components so as to form a tablet.

8. A computer system comprising:
at least one server computer; and,
at least one first client computer coupled to the at least one server computer through a network;
wherein the at least one server computer includes at least one program stored thereon, said at least one program performing the following steps:
selecting at least one first image;
selecting at least one second image;
selecting a movement path for the at least one second image; and,
creating a plurality of image frames,
wherein the at least one first image comprises a background image which remains stationary in each of the plurality of image frames, and wherein the at least one second image moves along the selected movement path so that it is disposed in a different position in each of the plurality of images frames.

9. A computer readable medium having embodied therein a computer program for processing by a machine, the computer program comprising:
a first code segment for permitting the selection of at least one first image;
a second code segment for permitting the selection of at least one second image;
a third code segment for permitting the selection of a movement path for the at least one second image; and,
a fourth code segment for creating a plurality of image frames,
wherein the at least one first image comprises a background image which remains stationary in each of the plurality of image frames, and wherein the at least one second image moves along the selected movement path so that it is disposed in a different position in each of the plurality of images frames.

10. A computer data signal embodied in a carrier wave comprising:
a first code segment for permitting the selection of at least one first image;
a second code segment for permitting the selection of at least one second image;
a third code segment for permitting the selection of a movement path for the at least one second image; and,
a fourth code segment for creating a plurality of image frames,
wherein the at least one first image comprises a background image which remains stationary in each of the plurality of image frames, and wherein the at least one second image moves along the selected movement path so that it is disposed in a different position in each of the plurality of images frames.

11. A tablet comprising a plurality of sheets of paper secured together by an adhesive, said tablet formed by the following steps:
selecting at least one first image;
selecting a movement path for the at least one first image;
creating a plurality of image frames, wherein the at least one first image moves along the selected movement path so that it is disposed in a different position in each of the plurality of images frames; and,
printing the plurality of image frames on a corresponding plurality of sheets of paper.

12. The tablet formed by the method of claim 11, comprising the further step of:
selecting at least one second image,
wherein the at least one second image comprises a background image which remains stationary in each of the plurality of image frames.
